(19) United States
(12) Patent Application Publication
(10) Pub. No.: US 2003/0100990 A1
(43) Pub. Date: May 29, 2003

(54) Using cellular network to estimate traffic flow

(76) Inventor: Edward O. Clapper, Tempe, AZ (US)

Correspondence Address: TROP PRUNER & HU, PC, 8554 KATY FREEWAY, SUITE 100, HOUSTON, TX, 77024, US

(21) Appl. No.: 09/997,091

(22) Filed: Nov. 28, 2001

(51) Int. Cl. G06G 7/76

(52) U.S. Cl. 701/117; 340/907

(57) ABSTRACT

Use of a delta in cellular device occupancy in cells of a cellular communication system to estimate vehicular traffic flow on roadways connecting the cells.

### BACKGROUND OF THE INVENTION

1. Technical Field of the Invention

The present invention relates generally to a system and method for estimating flow of e.g. automobile traffic, and more specifically to a system and method for doing so by using data from a cellular network such as a cellular telephone network.

2. Background Art

Cellular communications systems are known, such as cellular telephone systems. In some cellular systems, the communication area is divided into a number of cells. Each cell may be served by one or more communication sub-systems. In some embodiments, there may be some degree of overlap between adjacent cells. A communication device, such as a cellular telephone, communicates with one or more of these sub-systems. In some cases, a device may communicate with the cell sub-system which has the strongest communication signal at the location of the device. In some cases, the device may communicate with the nearest sub-system. In other cases, the device may communicate with a sub-system which is not the strongest and/or not the closest, for example to enable load balancing between the various sub-systems. In some cases, the device may be handed off from one sub-system to another, to permit dynamic load balancing.

Another common circumstance in which a device may be handed from one sub-system to another is the case of a mobile device which travels from one sub-system's area to another sub-system's area. As a device moves from one cell to another, the task of communicating with it is passed from one sub-system to another. In some cases, this may be centrally directed. In other cases, the sub-systems themselves may negotiate the handoff.

Cellular systems may be built using any wireless communication technique, whether it be via radio waves, broadband spread spectrum transmission, laser, satellite, or whatever suitable medium may be found for the particular application.

Most metropolitan areas are each divided into tens, hundreds, or thousands of cells. There may in many cases be overlapping entire cellular systems, such as one for consumer cellular telephones, one for industrial radios (such as the well-known Motorola radio system), and so forth.

FIG. 1 illustrates an exemplary map of a geographic area. The particular example given happens to be the highway system in the Phoenix, Arizona metropolitan area, but that is, of course, only one example.

Less intuitively, while the example is shown as a two-dimensional map adequate for describing the generally two-dimensional road system, the invention may equally well be applied in three dimensions, such as in the case of air travel. For ease of explanation, though, the two-dimensional example will be the one described.

The highway system (generally indicated as 15) includes seven highways (Hwy 10, Hwy 60, Hwy 17, Hwy 51, Hwy 143, Hwy 202, and Hwy 101) going to various destinations. The area does, of course, include a multitude of smaller roads, but those are omitted from this explanation for clarity and for ease of illustration. Hwy 10 includes non-linear segments connected at a series of turns. Hwy 60 includes two noncontiguous segments as illustrated; in actuality, the middle portions of Hwy 10 would likely be marked as belonging to both highways. Hwy 143 does not extend to any particular external destinations, but serves only as a connector between two other highways.

FIG. 2 illustrates an overly simplistic example of a cellular system 20 which includes a number of cells (A1-6, B1-6, . . . F1-6). For simplicity, the cells are shown as being of equal size, regular shape, and non-overlapping borders; in actuality, none of those are likely to be the case.

A cellular telephone customer traveling, for reasons known only to him, west to east from Buckeye to Globe, would pass through cells C1, C2, D2, D3, D4, D5, E5 and E6 in succession. As he reaches each cell boundary, the cellular system would hand him off from a prior cell to a next current cell.

Of course, that customer is not likely to be the only cellular customer traveling the highways of this map at this time. In actuality, there will generally be a very large number of cellular devices traveling these roads at any given time. There will also be a number of cellular devices which are on but which are not traveling, such as those in parked cars, in houses. There will generally also be some number of customers who are driving around, but are staying within a single cell's boundaries; in this case, these customers are not likely to be the ones using the highways, but are more likely to be those on surface streets.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows a map of the highway system.

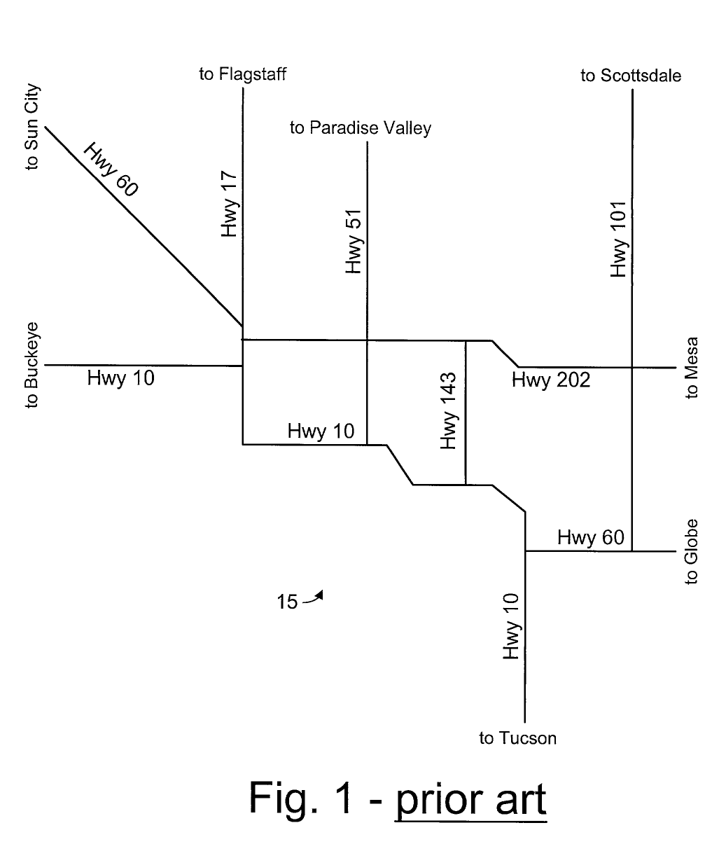

FIG. 2 shows the highway system overlaid with a cellular grid.

FIG. 3 shows a block diagram of an exemplary system employing this invention.

FIG. 4 shows a flowchart of an exemplary method of operation of the system.

FIG. 5 shows a flowchart of another exemplary method of operating the system.

FIG. 6 shows a heuristic diagram of traffic flow vectors.

FIG. 7 shows an exemplary display such as may be used with the traffic estimation system or a cellular device used with such.

FIG. 8 shows an exemplary cellular device that embodies the invention.

FIG. 9 shows the highway system overlaid with the cellular grid, and shows highway cell boundary crossings.

### DETAILED DESCRIPTION

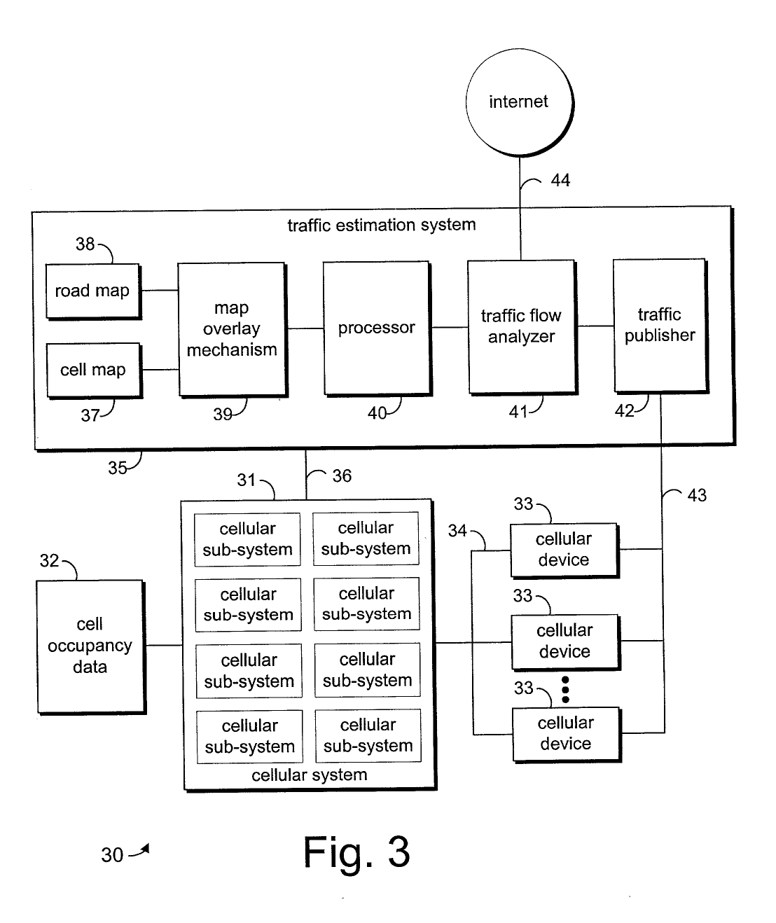

FIG. 3 illustrates one exemplary embodiment of a system 30 within which the present invention may be practiced. The system includes a cellular system 31 which includes a number of cellular sub-systems. The cellular system (and/or one or more of its sub-systems) maintains data 32 identifying which cellular devices are within the cells of which sub-systems, which may be termed cell occupancy data. The cellular system is in communication with a number of cellular devices 33 over any suitable communication medium 34 or media.

A traffic estimation system 35 is connected to receive the cell occupancy data from the cellular system, over any suitable communication mechanism 36. The traffic estimation system includes a cell map 37 identifying the locations of the cells in the cellular system. In one embodiment, the cell map may identify the locations of the cellular sub-systems such as the broadcast towers of such. In another embodiment, the cell map may define the boundaries of the cells. The skilled reader will, after gaining the teachings of this patent, be able to define a suitable cell map to suit a given application.

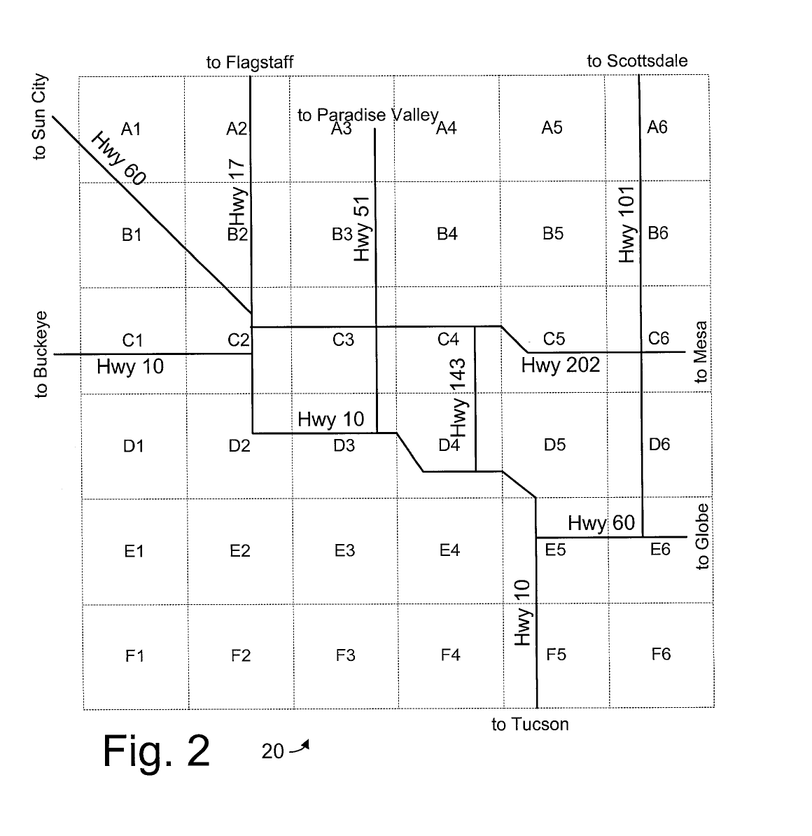

The traffic estimation system further includes a map 38 defining the two- or three-dimensional area at hand. In the example given, this would be a road map identifying the locations of the highways shown in FIG. 2. In one embodiment, the road map may be defined in conventional cartographic terms, such as “highway 101 goes from point X to point Y” where X and Y are expressed as Global Positioning System coordinates, longitude/latitude, or other suitable terms. In another embodiment, the road map may be defined in terms of the associated cellular map (or vice versa), such as “highway 202 goes from cell C6 to cell C5 to cell C4 to cell C3 to cell C2” or the like. Again, after gaining the teachings of this patent, the skilled reader will be able to construct a suitably configured road map to meet the given application.

The traffic estimation system includes a map overlay mechanism 39 which facilitates the coordination of the cell map with the road map. In some embodiments, the overlay will be inherent in the expression of one map in terms of the other, as in the highway 202 example in the preceding paragraph.

The traffic estimation system includes a processing mechanism 40 for performing logic operations of the method of the invention. In one embodiment, the processing mechanism maybe a single digital microprocessor. In another embodiment, it may take the form of a distributed algorithm utilizing e.g. the processing power of the various cellular devices themselves. Other embodiments will be apparent to the skilled reader.

The traffic estimation system includes a traffic flow analyzer 41 which performs analysis upon the cell occupancy data in light of the road map and cell map. In one embodiment, the traffic flow analyzer may simply be a computer program executing on the processing mechanism. In other embodiments, it may be, for example, a dedicated hardware mechanism.

In some embodiments, the traffic estimation system may optionally include a traffic publisher 42 which communicates the results of the traffic analysis directly to one or more of the cellular devices—such as those for which a subscription fee has been paid. In some embodiments, this communication may utilize the existing cellular system, while in others, it may utilize a separate back channel 43 or other communication link. The results may also be published to other entities, such as a police department, department of transportation, a news bureau, a radio station, a television station, a server computer, an internet website, or any other suitable recipient. In some such embodiments, the results may be published to the internet 44 over any suitable connection 45.

As suggested in FIG. 3 by the direct connection of the traffic flow analyzer to the internet, in some embodiments, the traffic flow analyzer may itself communicate the results rather than doing so through a separate traffic publisher, and in some embodiments, there may be multiple publishing links which may connect to different entities or a same entity within the traffic estimation system.

The reader will appreciate that the traffic estimation system may be incorporated as a part of the cellular system, rather than as a stand-alone entity. It may even be embodied in the cellular devices themselves, if desired.

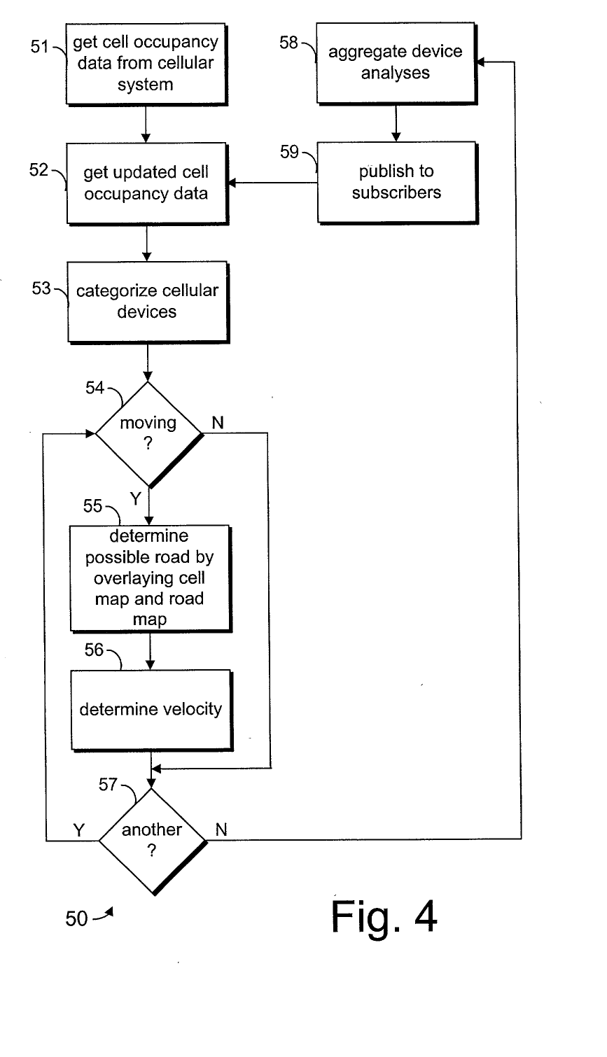

FIG. 4 illustrates one exemplary method 50 of operation of the traffic estimation system or a cellular device incorporating such. The traffic estimation system receives (51) the cell occupancy data from the cellular system, then later receives (52) updated occupancy data. In some embodiments, the entire data set may be received a second time, while, in others, only the delta or changed data may be received. The skilled reader will appreciate that it may be desirable to use more than two snapshots of the data, and that two snapshots or data sets are shown by way of illustration only. If a cellular device is moving sufficiently slowly, or if the data sets are captured sufficiently close in time, a two-set picture may not yield sufficiently useful data in some applications.

According to the differences or changes in the two data sets, the map overlay mechanism categorizes (53) the cellular devices for which there are data. One categorization is to determine (54) whether a given cellular device is moving from cell to cell. If it is moving, the overlay mechanism compares (55) the cell occupancy data against the cell map, and the cell map against the road map, to determine which of the highways the cellular device is traveling. The skilled reader will, of course, appreciate that the overlay mechanism may be constructed to deal with probabilities rather than absolutes. In other words, the overlay mechanism may determine that the given cellular device is likely to be on the indicated highway, not necessarily that it is absolutely on that highway. The probability may itself be characterized over a range of values, based on a variety of factors and other data. For example, if the overlay mechanism determines (56) that the cellular device appears to be traveling at fifteen miles per hour, and stopping every half mile for roughly the duration of a traffic light, the overlay mechanism may deduce that the cellular device is on a surface street and not one of the highways in question. Or, the overlay mechanism may notice that this particular cellular device is traveling at only one third the velocity of other cellular devices which are believed to be on the highway, and may therefore deduce that the particular device is not on the highway.

If (57) there are more cellular devices to be analyzed, operation may proceed (to 54) for each of those devices in turn.

Once the entire set, or a sufficiently numerous set, of the available cellular devices' occupancy data have been analyzed, the traffic flow analyzer can perform (58) aggregate device analyses. For example, the traffic flow analyzer may determine that traffic on highway 202 has ground to a halt, perhaps due to an automobile crash or the asphalt melting under the July sun. Or, the traffic flow analyzer may determine that N automobiles are on highway 101 while only a small fraction of that number are on highway 51, which goes to generally the same destination. As another example, the traffic flow analyzer could determine that there is a trend of slower traffic at a point where multiple routes converge. The skilled reader will appreciate a wide variety of usage models for the traffic flow analyzer, and any number of specific data checks and analyses that it could perform.

Once the analysis has been performed, the traffic publisher may optionally publish (59) some or all of the results to some or all of its subscribers or other entities. For example, the traffic publisher may simply broadcast “avoid highway 101” or “highway 202 running smoothly” for the world to see. However, that itself might cause problems, if an unduly large number of drivers heed the advice, and suddenly highway 101 is wide open and highway 202 is bumper-to-bumper. Thus, the traffic publisher may invoke any of a number of policies to prevent causing harm to the system. For example, the results could be posted only to those subscribers who have even telephone numbers. Or, they could be posted only to those subscribers presently in a particular cell area. The traffic publisher could even publish misleading reports to subscribers who are more than sixty days late making payment.

The method is, of course, not limited to this example. For example, the system could additionally have the ability to isolate individual cellular devices and perform further analysis upon them, perhaps even on an individual basis. In some such embodiments, it may be desirable to provide a mechanism for performing individual analysis in an anonymized environment, to reassure subscribers that their individual movements are not being tracked. Such additional analysis might include, for example, redundancy checking or revalidating various assumptions that the system is using. As another example, when the traffic flow analyzer determines that there is congestion at a convergence point of multiple routes, it could further investigate movement of anonymized individual cellular devices at that convergence point, to validate its determination with actual, individual data.

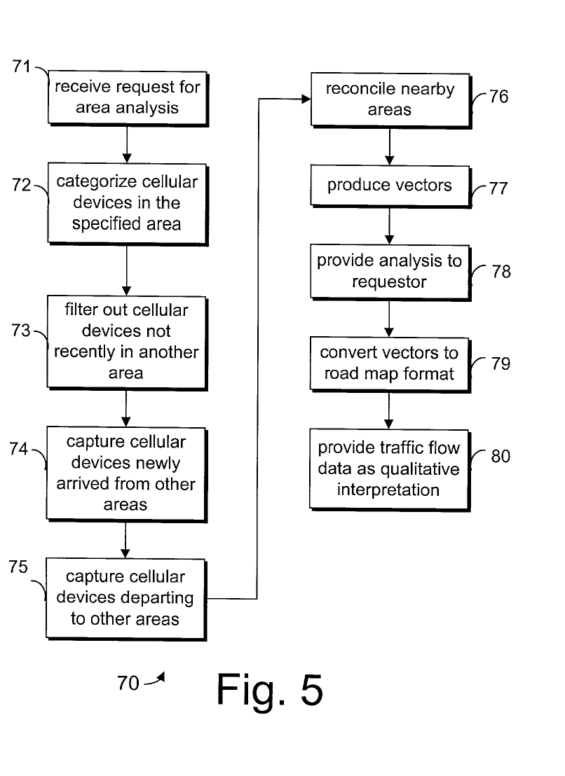

FIG. 5 illustrates another example of a method 70 of operation of the traffic estimation system (or a cellular device incorporating such, although the method will be described as being practiced on a traffic estimation system, for simplicity). When the method is practiced in the traffic estimation system, the system receives (71) a request for traffic flow estimation or analysis of an area. This request may come from a cellular device, such as a customer inquiring what roads to avoid, or it may come from another entity, such as a police department deciding where to send patrol cars, or any other entity.

The traffic estimation system categorizes (72) the cellular devices in the specified area. In some embodiments, no area is specified, and all areas can be categorized. The specification of an area can be express, such as “tell me about traffic near the 202/101 interchange” or “tell me about traffic in cell B3”. Or, the specification can be inherently assumed, such as the area from which the cellular device is making the request, or perhaps the area toward which the cellular device is heading.

In making the characterization, the traffic estimation system can filter out (73) cellular devices in the specified area that have not recently been in other areas. This will tend to eliminate from the traffic estimation those cellular devices which are not presently on the road and those which are driving only within a localized area, such as those on surface streets, and those which have only just been turned on.

The traffic estimation system captures or identifies (74) cellular devices newly arrived to the area from other areas, and captures or identifies (75) cellular devices departing to other areas, which are not to be included in the particular analysis or estimation being undertaken.

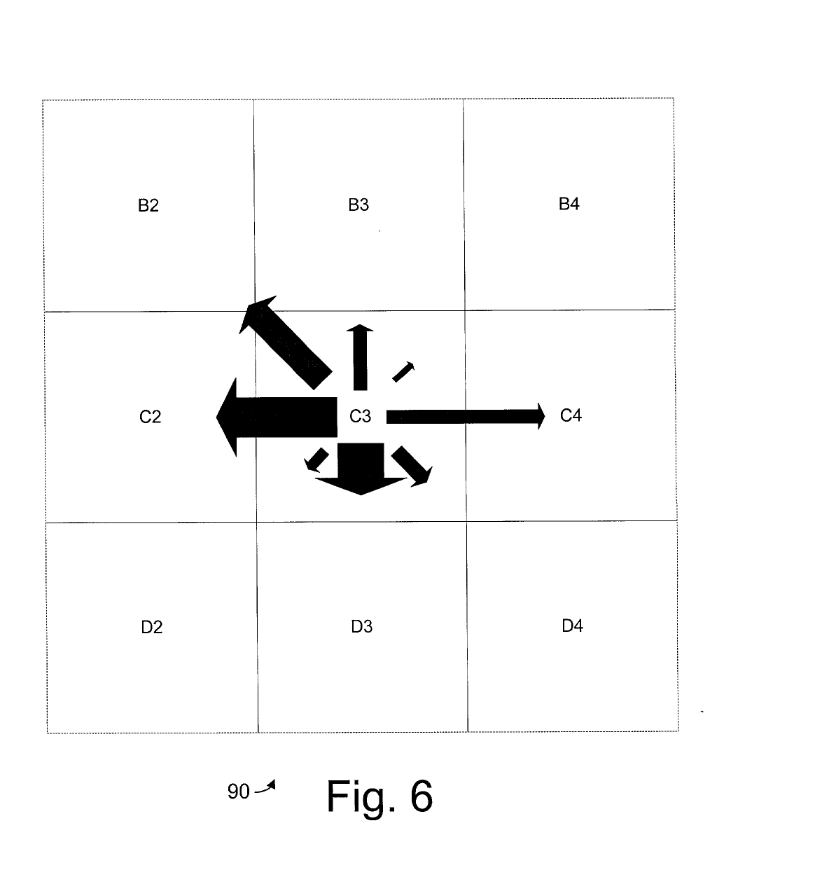

The traffic estimation system reconciles (76) the occupancy data of the specified area with those of nearby or adjacent areas. From the resulting, filtered data, the traffic estimation system may produce (77) a set of vectors (described below with regard to FIG. 6), analyzes those, and provides (78) the resulting analysis to the requesting entity.

In some embodiments, these vectors may be converted (79) to a more visually meaningful road map format prior to being sent to the requesting entity, or by the requesting entity itself, to provide (80) a qualitative interpretation of the estimated traffic flow.

FIG. 6 illustrates, in diagrammatic form, one exemplary set of vectors describing traffic flow from on cell (C3) to surrounding cells. The vectors may be represented graphically, or numerically, or in any suitable manner. In the embodiment illustrated, the width of a vector may represent the volume of traffic flowing in the indicated direction to the nearby or adjacent cell, while the length of the vector may represent, for example, an average or maximum speed of vehicles traveling in that direction. Thus, by referring to FIG. 6 and FIG. 2, it can be determined that the FIG. 6 vectors indicate that traffic on westbound Hwy 202 (from C3 to C2) is heavy but moving, traffic on eastbound Hwy 202 (from C3 to C4) is light and moving very rapidly, traffic from C3 to B4 is almost nonexistent (which is to be expected, as there is no highway connecting those cells, and thus the vector may be ignored for highway traffic analysis purposes), and so forth.

By performing such analysis on a number of the cells, a more complete traffic picture can be constructed. For example, the analysis on C4 would include results for a C4-to-C3 vector, yielding data about traffic flowing into cell C3 (whereas the simplistic example in the prior paragraph only concerned traffic flowing out of cell C3). This will give deeper insight into traffic along longer stretches of a given highway, as well. For example, if traffic from C3 to C2 is very heavy but moving, but traffic from C2 to C1 (not shown, but is to the left of C2) is extremely heavy and hardly moving at all, it can be deduced that there is a problem such as a crash or a closed lane farther to the west than C3, and that some of the C4-to-C3 traffic should be diverted in order to miss that event.

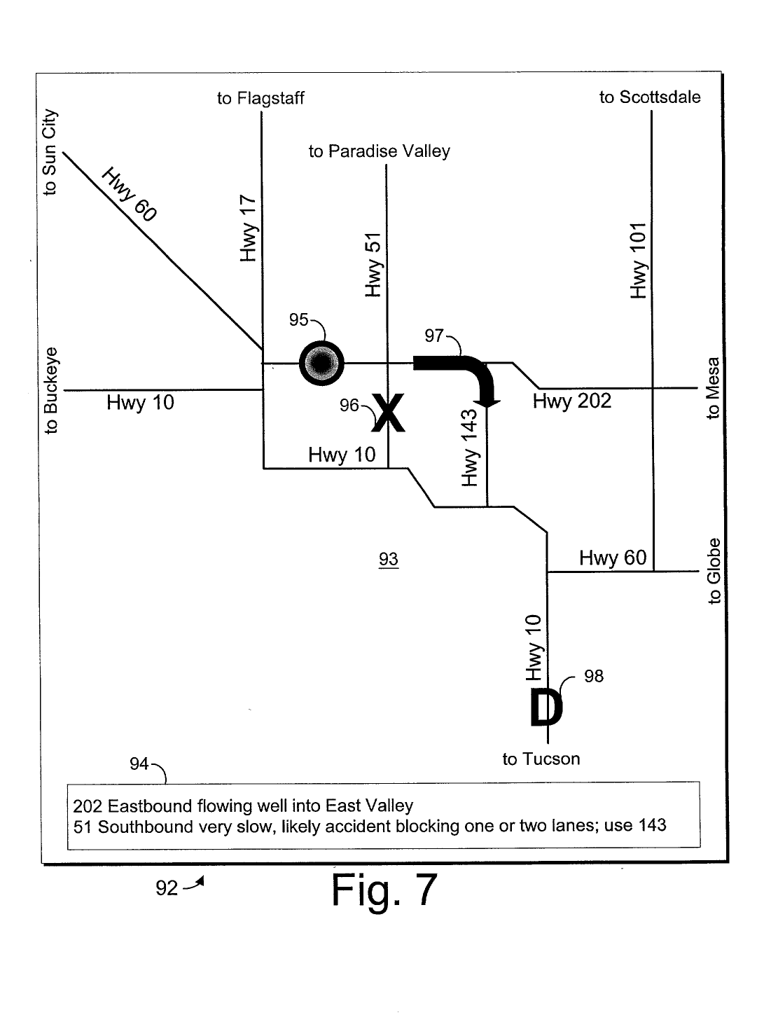

FIG. 7 illustrates one exemplary graphical or video display 92 such as may be presented at a cellular device or other requesting or monitoring entity. The display may include a road map 93 displayed in any suitable format, or in some embodiments a cell map (not shown) either alone or overlaid with the road map. In embodiments in which the display is part of or used in conjunction with the cellular device, the display may advantageously include a “you are here” indicator 95 and a destination indicator 98.

The map display may further include one or more “avoid this road” indicators such as mark 96, and/or one or more “suggested route” markers such as arrow 97. These may be derived from the vectors or other traffic flow analysis results, as appropriate.

In some embodiments, the display 92 may further or alternately include a textual display area 94 for displaying message information. The message information may, or may not necessarily, relate to the graphical indicators such as 96 and 97.

In some embodiments, the display may be used in conjunction with a Global Positioning System (GPS) or other such positioning apparatus. The GPS may be used, for example, to accurately place the “you are here” indicator and/or to orient the map in “direction of travel UP” mode (as opposed to “north UP” mode).

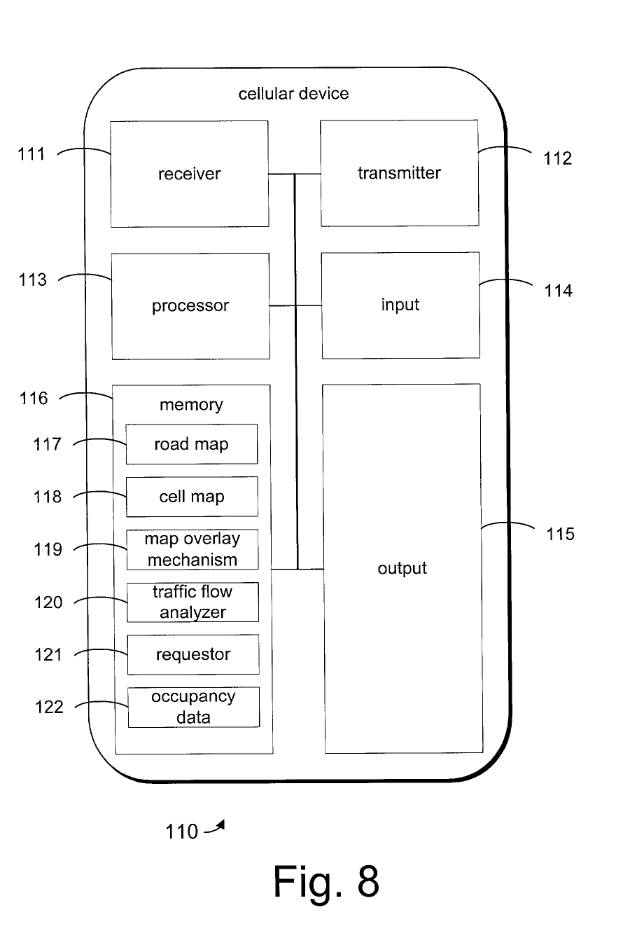

FIG. 8 illustrates one exemplary embodiment of a cellular device 110 adapted to perform the method of this invention. The cellular device includes a receiver 111 and a transmitter 112 for communicating with the cellular system. In some embodiments, the cellular device may include a separate communication mechanism (not shown) for back-channel communication with a traffic publisher (42 in FIG. 3), or the receiver and transmitter may be modified to incorporate such.

The cellular device may further include a processor 113 for performing logical operations, including some or all of the logic operations of the method of this invention, and typically also other operations for conventional cellular usage and the like.

The cellular device may include an input 114 such as a keypad, and an output 115 such as a liquid crystal display for presenting maps and other data to the user.

The cellular device may further include one or more types of memory 116, such as random access memory, read-only memory, flash memory, rotating storage, polymer ferro-electric memory, optical storage, magnetic storage, or any other suitable memory devices. The memory may include data comprising a road map 117 in any suitable format, data comprising a cell map 118 in any suitable format, a map overlay mechanism 119, a traffic flow analyzer 120, a requestor 121 for issuing requests (such as for updated traffic analysis, or for refreshed road or cell map data) to the traffic analysis system or the cellular system, and data representing cell occupancy data 122.

The input 114 may include one or more controls, such as buttons or other suitable controls for zooming the display in and out, buttons or other suitable controls for scrolling the display up, down, left, and right, and so forth. These are well within the abilities of those having ordinary skill in the relevant arts, and thus will not be discussed in detail here.

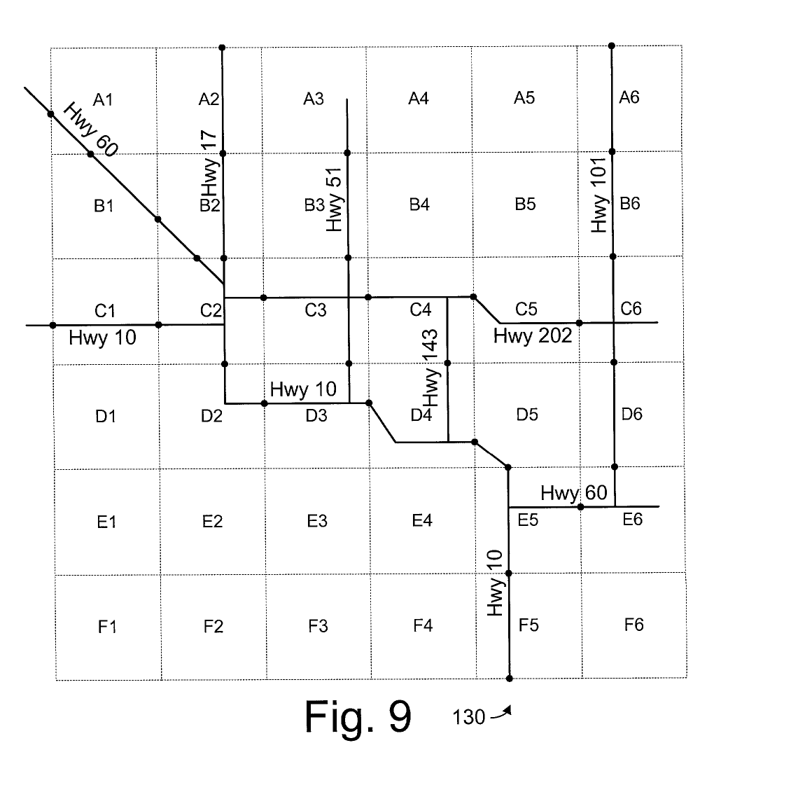

FIG. 9 illustrates, in diagrammatic form 130, one alternative method of representing the road map, or of overlaying the road map and the cell map. For purposes of this invention, it may, in some embodiments, not be necessary to keep track of the actual geographic route that a particular stretch of highway takes within a given cell; rather, it may be sufficient to keep track of the cell boundaries that are connected by that stretch of road. These boundary crossings are denoted in FIG. 9 as black dots, but could be denoted in a wide variety of other manners. A highway may be represented as a logical series of cellular boundary points, each point representing the location where the highway coincides with the intersection of two adjoining cells. Within the overlap and variance limits, this represents a specific repeatable geographic region, well within the resolution of the application.

For example, Hwy 10 may be represented by the following set of tuples, which may be stored as a linked list, a table, or in any other suitable format:

| | | | |
|---|---|---|---|
| (C1W,C1C2) | (C2C1,C2D2) | (D2C2,D2D3) | (D3D2,D3D4) |
| (D4D3,D4D5) | (D5D4,D5E5) | (E5D5,E5F5) | (F5E5,F5S) |

In this example, the boundary C1C2 denotes the boundary crossed when going from cell C1 to cell C2, while the boundary C2C1 indicates that same boundary but expressed as going from cell C2 to cell C1, or, in other words, from the C2 cell's point of view. The boundary F5S denotes the southern boundary of cell F5, which notation may be used when, for example, a particular cell does not have a neighboring cell at that particular boundary.

Hwy 51 might be represented as:

(A3C,A3B3) (B3A3,B3C3) (C3B3,Hwy202,C3D3) (D3C3,Hwy10)

The notation A3C denotes a location central to or within cell A3, as opposed to one of that cell's boundaries. The third tuple is a triplet including an indication that Hwy 51 intersects with Hwy 202 somewhere in cell C3, along the segment that connects the C3B3 boundary crossing to the C3D3 boundary crossing.

Various other representations are certainly conceivable and within the scope of this invention.

Conclusion

In various embodiments, the various functionalities described herein may be partitioned in various manners, and may be distributed between the cellular device, traffic analysis system, and/or cellular system in any of a variety of ways.

The reader should note that the term “determine” may include “estimate” or “calculate” or other such functionalities.

The reader should appreciate that drawings showing methods, and the written descriptions thereof, should also be understood to illustrate machine-accessible media having recorded, encoded, or otherwise embodied therein instructions, functions, routines, control codes, firmware, software, or the like, which, when accessed, read, executed, loaded into, or otherwise utilized by a machine, will cause the machine to perform the illustrated methods. Such media may include, by way of illustration only and not limitation: magnetic, optical, magneto-optical, or other storage mechanisms, fixed or removable discs, drives, tapes, semiconductor memories, organic memories, CD-ROM, CD-R, CD-RW, DVD-ROM, DVD-R, DVD-RW, Zip, floppy, cassette, reel-to-reel, or the like. They may alternatively include down-the-wire, broadcast, or other delivery mechanisms such as Internet, local area network, wide area network, wireless, cellular, cable, laser, satellite, microwave, or other suitable carrier means, over which the instructions etc. may be delivered in the form of packets, serial data, parallel data, or other suitable format. The machine may include, by way of illustration only and not limitation: microprocessor, embedded controller, PLA, PAL, FPGA, ASIC, computer, smart card, networking equipment, or any other machine, apparatus, system, or the like which is adapted to perform functionality defined by such instructions or the like. Such drawings, written descriptions, and corresponding claims may variously be understood as representing the instructions etc. taken alone, the instructions etc. as organized in their particular packet/serial/parallel/etc. form, and/or the instructions etc. together with their storage or carrier media. The reader will further appreciate that such instructions etc. may be recorded or carried in compressed, encrypted, or otherwise encoded format without departing from the scope of this patent, even if the instructions etc. must be decrypted, decompressed, compiled, interpreted, or otherwise manipulated prior to their execution or other utilization by the machine.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An apparatus comprising:
a cellular map of cellular communication cells in a geographic area;
a road map of vehicular roads in substantially the same geographic area; and
a traffic flow analyzer coupled to the cellular map and the road map to determine vehicular traffic in at least one part of the geographic area.

2. The apparatus of claim 1 wherein the at least one part of the geographic area comprises at least one cell of the cellular communication cells.

3. The apparatus of claim 1 wherein the at least one part of the geographic area is expressed in geographic terms including a reference to at least one of the vehicular roads.

4. The apparatus of claim 1 further comprising:
means for determining a delta over time in occupancy data for at least one cell of the cellular communication cells.

5. The apparatus of claim 1 further comprising:
a communication link for transmitting information concerning the vehicular traffic.

6. The apparatus of claim 5 wherein the communication link comprises:
a link to cellular devices which are coupled to the cellular communication cells.

7. The apparatus of claim 5 wherein the communication link comprises:
means for transmitting the information onto the internet.

8. The apparatus of claim 1 further comprising:
a processor coupled to the traffic flow analyzer.

9. The apparatus of claim 1 further comprising:
a map overlay mechanism for correlating the cellular map and the road map.

10. A cellular communication device for communicating with a cellular system, the cellular communication device comprising:
a receiver to receive communications from the cellular system;
a transmitter to transmit communications to the cellular system;
map storage to store a map; and
an analyzer coupled to the receiver to receive cell occupancy data from the cellular system and to the storage to access the map to determine traffic in at least one cell of the cellular system according to the occupancy data and the map.

11. The cellular communication device of claim 10 further comprising:
means for requesting the cell occupancy data; and
storage to store the cell occupancy data.

12. The cellular communication device of claim 10 wherein:
the cellular communication device further comprises data storage to store the occupancy data;
the occupancy data includes first occupancy data and second occupancy data for the at least one cell; and
the analyzer determines traffic according to a delta between the first occupancy data and the second occupancy data.

13. The cellular communication device of claim 12 further comprising:
an overlay mechanism for geographically correlating a cell map and a road map in the map storage.

14. The cellular communication device of claim 13 wherein the traffic includes vehicular traffic and the cellular communication device further comprising:
a display for outputting information depicting the vehicular traffic.

15. The cellular communication device of claim 12 further comprising:
a zoom control.

16. The cellular communication device of claim 12 further comprising:
means for updating the map storage to store a new map received via the receiver.

17. A cellular communication system providing cellular communication to an area including a plurality of cells, the cellular communication system comprising:
first storage to store a cell map;
second storage to store cell occupancy data;
means for detecting and analyzing a change in the occupancy data of a first cell; and
means for changing a functionality of the cellular system's communications in at least one cell of the plurality of cells.

18. The cellular communication system of claim 15 wherein:
the means for detecting and analyzing a change in the occupancy data of the first cell detects a volume of traffic moving into or out of the first cell; and
the means for changing alters an amount of bandwidth allocated to a second cell which is near the first cell.

19. The cellular communication system of claim 18 wherein the traffic includes vehicular traffic traveling on roads that connect various of the cells and wherein the cellular communication system further comprises:
third storage to store a road map of the roads; and
a map overlay mechanism to correlate the road map with the cell map.

20. The cellular communication system of claim 19 further comprising:
means for providing, to cellular devices in communication with the cellular communication system, information concerning the vehicular traffic flow.

21. A method comprising:
determining a delta in occupancy data of at least one cell of a cellular communication system; and
determining, according to the delta in occupancy data, spatial movement of cellular devices in communication with the cellular communication system.

22. The method of claim 21 wherein the spatial movement comprises substantially planar movement of vehicular traffic.

23. The method of claim 21 wherein the spatial movement comprises three-dimensional movement of aeronautical traffic.

24. The method of claim 21 further comprising:
determining the delta according to a proper subset of available occupancy data for a cell.

25. The method of claim 24 further comprising:
randomly selecting the proper subset.

26. The method of claim 24 further comprising:
algorithmically selecting the proper subset.

27. The method of claim 21 further comprising:
publishing information representing the spatial movement.

28. The method of claim 27 wherein the publishing comprises:
transmitting the information to cellular devices in communication with the cellular communication system.

29. The method of claim 28 wherein the information comprises:
a graphical depiction of traffic on roads in the cell occupied by, and neighboring cells of, at least one cellular device.

30. The method of claim 28 wherein the information comprises:
travel routing advice.

31. The method of claim 27 further comprising:
selecting, to receive the transmitted information, substantially only those cellular devices which are subscribed to receive the transmitted information.

32. The method of claim 27 wherein the publishing comprises:
sending the information to an entity which is not a cellular device in communication with the cellular communication system.

33. The method of claim 32 wherein the entity comprises at least one of a police department, a department of transportation, a news bureau, a radio station, a television station, a server computer, and an internet website.

34. The method of claim 21 further comprising:
constructing a set of vectors representing vehicular traffic between cells of the cellular communication system.

35. The method of claim 34 further comprising:
constructing a linear boundary map describing where vehicular roads connect cells.

36. The method of claim 21 further comprising:
in response to at least one of the delta and the spatial movement, adjusting functionality of the cellular communication system.

37. The method of claim 36 wherein the adjusting functionality comprises:
increasing capacity of a cell.

38. The method of claim 37 further comprising:
in response to at least one of the delta and the spatial movement, predicting a future change in occupancy of a cell; and
the cell whose capacity is increased is the cell whose occupancy is predicted to have a future change.

39. A method of operation of a traffic estimation system connected to a cellular communication system which is in communication with a plurality of cellular devices, the method comprising:
receiving cell occupancy data from the cellular communication system;
determining which of the cellular devices represented by the cell occupancy data are moving between cells of the cellular communication system;
determining which cells the moving cellular devices are moving between; and
converting the moved-between cell determination into a vehicular roadway representation indicating which roads the moving vehicles are likely to be driving on.

40. The method of claim 39 further comprising:
ignoring cellular devices which are not traveling between cells for a sufficient time such that it is likely that they are stationary or only driving short distances within their respective cells.

41. The method of claim 39 further comprising:
analyzing only a proper subset of available cell occupancy data; and
extrapolating from the resulting analysis to achieve an estimated result for a larger set of occupancy data.

42. The method of claim 41 further comprising:
randomly selecting the proper subset.

43. The method of claim 41 further comprising:
algorithmically selecting the proper subset.

44. The method of claim 39 further comprising:
publishing information representing the vehicular roadway representation.

45. The method of claim 44 wherein the publishing comprises:
transmitting the information to the cellular communication system.

46. The method of claim 44 wherein the publishing comprises:
transmitting the information to at least one of the cellular devices.

47. The method of claim 46 further comprising:
selecting to receive the transmitted information substantially only those cellular devices which are subscribed to receive the transmitted information.

48. The method of claim 39 further comprising:
performing system validation analysis upon anonymized individual cellular devices.

49. A method comprising:
receiving a request for an area traffic analysis in a specified area;
categorizing cellular devices in the specified area;
filtering out cellular devices not recently in other areas;
capturing cellular devices recently arrived from other areas;
eliminating cellular devices departing to other areas;
reconciling a result with results from nearby areas to produce a result;
providing the result to an entity from which the request was received.

50. The method of claim 49 further comprising:
producing a cell-based vector set; and
converting the vector set into road map format data.

51. The method of claim 50 further comprising:
making a qualitative interpretation of the road map format data as a traffic flow estimation.

52. An article of manufacture comprising:
a machine-accessible medium including data that, when accessed by a machine, cause the machine to perform the method of claim 21.

53. The article of manufacture of claim 52 wherein the machine-accessible medium further including data that, when accessed by the machine, cause the machine to further perform the method of claim 24.

54. An article of manufacture comprising:
a machine-accessible medium including data that, when accessed by a machine, cause the machine to perform the method of claim 39.

55. The article of manufacture of claim 54 wherein the machine-accessible medium further including data that, when accessed by the machine, cause the machine to further perform the method of claim 41.

56. An article of manufacture comprising:
a machine-accessible medium including data that, when accessed by a machine, cause the machine to perform the method of claim 49.

57. The article of manufacture of claim 56 wherein the machine-accessible medium further including data that, when accessed by the machine, cause the machine to further perform the method of claim 51.
